(19) United States
(12) Patent Application Publication
(10) Pub. No.: US 2026/0347140 A1
(43) Pub. Date: Nov. 5, 2026

(54) HYBRID STRINGING ASSEMBLY AND METHODS THERETO

(71) Applicant: SHERMAN + REILLY, INC., Chattanooga, TN (US)

(72) Inventors: Joshua Cooper COLLINS, Chattanooga, TN (US); Douglas Bruce MACDONALD, Chattanooga, TN (US); Anthony Keith MAXWELL, Chattanooga, TN (US); Lillian Nichole SHELTON, Chattanooga, TN (US); Toni Corinne TRAN, Chattanooga, TN (US); Timothy Michael HANSON, Chattanooga, TN (US)

(21) Appl. No.: 19/124,691

(22) PCT Filed: Aug. 22, 2023
(86) PCT No.: PCT/US23/72604

§ 371 Date: Apr. 25, 2025

Related U.S. Application Data
(60) Provisional application No. 63/419,402, filed on Oct. 26, 2022.

(51) Int. Cl. B65H 75/44; B65H 75/42; H02G 1/04; H02G 1/06

(52) U.S. Cl. CPC B65H 75/4407; B65H 75/425; H02G 1/04; H02G 1/06; B65H 2403/92; B65H 2553/27; B65H 2553/41

(57) ABSTRACT

The disclosed technology includes a stringing apparatus having a driveline configured to receive a cable, a levelwind configured to align the cable with the driveline, and a machine monitor configured to detect a position of objects on or near the stringing apparatus. The disclosed technology can include a control system configured to receive data from the machine monitor. The data can include position data of the levelwind. The control system can be further configured to output a control signal to adjust a position of the levelwind based at least in part on the position data. The stringing apparatus can be further configured to control an output of the driveline based on a temperature or charge level of an energy store. The stringing apparatus can be further configured to preload an engine that is configured to drive an electric motor to drive the driveline.

### CROSS-REFERENCE TO RELATED APPLICATIONS

This application is a Patent Cooperation Treaty (PCT) application of, and claims priority under Article 8 of the PCT to, U.S. Patent Application No. 63/419,402, filed 26 Oct. 2022, the entire contents of which are fully incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The invention is in the field of cable stringing apparatuses and methods, and, more particularly, to hybrid systems and methods.

### 2. Description of Related Art

High voltage utility transmission lines can transmit power over hundreds of miles with minimal losses because of the very high voltages used. Step-up transformers located at utility power generation plants increase the voltage transmission levels which minimizes losses due to the resistance of the transmission line (i.e., the conductor). As electrical demand continues to grow, higher-capacity lines and/or additional lines are needed.

Equipment and tools for overhead and underground power line installation and maintenance include pullers, tensioners, bundle blocks, reel trailers, and battery tools.

Exemplary equipment includes, among others, Sherman+Reilly's PT-3000 Puller Tensioner combining a puller, tensioner, and reconductorer in a single unit for overhead or underground applications. It has dual overhead and underground hydraulic levelwind, a direct drive hydrostatic motor, and a mechanical spline engagement system. It is capable of pulling 3,000 lbs. and tensioning 2,000 lbs.

As another example, the PTX-3500 Puller Tensioner has a fully hydraulic direct drive system, and is capable of pulling up to 3,500 lbs. with additional re-conductoring capabilities, and tensioning up to 2,000 lbs. Hydraulic motor optimization allows for low force pull off at higher speeds and a hydraulic levelwind incorporates two cylinders that allow the levelwind to move smoothly and efficiently.

The P-1400X Puller is a puller and reconductorer in one unit with a pulling capacity of 14,000 lbs.

The Sherman+Reilly BWT 1363 Tensioner is completely hydraulic, equipped with either gas or diesel power. In a tensioning mode, the BWT 1363 Tensioner maintains a positive controlled pressure during the tensioning operation. The unit will also operate in either direction and may be used for either reeving, paying out or pulling back on the conductor. The system is equipped with a spring applied emergency brake which will automatically apply if hydraulic pressure is lost for any reason. Brakes may be applied manually when desired to park the system. The direction control lever is used to select either the Pay Out or Pull In mode. The line tension control is used to regulate the conductor tension during stringing. The hydraulic pressure gauge is used to display the hydraulic system pressure during operation.

Stringing high-voltage conductor lines across significant distances requires the use of conductor stringing apparatuses. The installation of power transmission lines and communication lines, sometimes referred to as “pulling conductors”, or “tension stringing” utilizes a number of components spread over a wide area. A device called a conductor or cable puller-tensioner is used, although those of skill in the art know that other terms are used for this equipment. The equipment is typically termed by what it does.

The stringing equipment typically work in pairs: a puller for pulling a cable element (conductors, fiber optic cables, and the like) through stringing sheaves of utility structures, like poles and towers, and a tensioner providing resistance to the cable. The paired equipment can be designed for only its purpose—a puller that only performs pulling and a tensioner that only provides tension, or one or both of the pair of equipment can be a unit capable of performing both as a puller and a tensioner, and during any stringing operation performing its specific set of tasks depending on which side of the stringing operation they are located.

A puller is set up at one end of the line section to perform the pulling operation, and a tensioner to perform the tensioning operation at the other end. Typically, a reel of conductor is staged behind the tensioner. A pulling line is strung from the puller, through stringing blocks between the puller and tensioner. The end of the pulling line is then attached to the conductor end after it has been threaded through the tensioner.

During the stringing process, the conductor is pulled through the stringing sheaves until the end reaches the puller. The tension maintained between the tensioner and the puller keeps the conductor clear of the ground and other obstructions that could cause damage.

A puller-tensioner is provided with one or more drivelines (for example, depending on the machine, drums, spools, bull wheels, screwing systems, other pulling systems, pulling system and the like), a driveline for each cable to be strung. The driveline of the puller is equipped with power for pulling with a force greater than the braking action of the tensioner at the other end of the line. The “pulling” can be via rotation of a drum, or via alternating action for pulling the conductor, or a hand-over-hand pull, or other actions that pull the conductor.

The length of the conductor being pulled/installed can be over a mile long. A running board can also be attached to the conductors, which can in turn be attached to the pulling line that pulls the running board and conductors through the stringing sheaves of the utility structures.

For simplicity, as used herein the term “puller-tensioner” includes units that only function as a puller, units that only function as a tensioner, and units that can function as both a puller and a tensioner. When appropriate for context, the term “puller” and/or “tensioner” is also used. Furthermore, throughout this disclosure, the terms “stringing equipment” or “stringing apparatus” is used to describe any type of equipment used to string electrical or communication lines such as bullwheel tensioners, pilot line winders, pullers, puller-tensioners, reconductorers, or various combinations of stringing equipment. Furthermore, the terms “stringing equipment” or “stringing apparatus” can include both overhead and underground stringing equipment, or combinations thereof.

Conventional pullers and tensioners are powered by internal combustion engines driving a hydraulic system that, with appropriate gearing, rotates the driveline at the specified torque and speed to pull the pulling line/conductor. Tensioning is performed by controlling the hydraulic pressure within the tensioner's system and/or via mechanical brakes, resisting the rotation of the tensioner's driveline (being for example a drum) and creating the desired tension in the conductor line.

Reliance only on internal combustion engines for power supporting puller-tensioners presents a number of drawbacks. Internal combustion engines are noisy and thus disadvantageous when used in areas that govern limited noise pollution. Internal combustion engines are relatively heavy polluters and thus disadvantageous to good environmental stewardship. Additionally, the drive output of an internal combustion engine is tied to the combustion engine's torque curve, which can be disadvantageous when used with pullers and tensioners.

It is, therefore, desirable to augment power supplied conventionally only by internal combustion engines/generators if not remove completely the dependence upon internal combustion engines in pushing and/or pulling operations. To the extent it remains beneficial to have pushing and/or pulling equipment supplied with both an engine and electric power in appropriate situations, it is an object of the present invention to combine both engine technologies with electric technologies to provide a hybrid puller-tensioner and processes regarding same. Aspects of the present disclosure address these and other issues.

### BRIEF SUMMARY OF THE INVENTION

The disclosed technology includes a stringing apparatus having a driveline configured to receive a cable, a levelwind configured to align the cable with the driveline, and a machine monitor configured to detect a position of objects on or near the stringing apparatus. The disclosed technology can include a control system configured to receive data from the machine monitor. The data can include position data of the levelwind. The control system can be further configured to output a control signal to adjust a position of the levelwind based at least in part on the position data.

The machine monitor can be further configured to detect a diameter of the cable. The control system can be configured to receive diameter data from the machine monitor and output a control signal to adjust the position of the levelwind based at least in part on the diameter data.

The driveline can be a first driveline, the cable can be a first cable, the levelwind can be a first levelwind, and the position data can be first position data. The stringing apparatus can further include a second driveline configured to receive a second cable and second levelwind configured to align the second cable with the second driveline. The control system can be further configured to receive second position data indicative of a position of the second levelwind and output a control signal to adjust the positions of the first levelwind and the second levelwind based at least in part on the first position data and the second position data.

The control system can be further configured to adjust a position of the first levelwind and the second levelwind approximately simultaneously. Adjusting the position of the first levelwind and the second levelwind can be an asynchronous mode.

The machine monitor can be further configured to detect a presence of a person near the stringing apparatus. The machine monitor can be further configured to detect a distance between the person and the stringing apparatus.

In response to determining that the person is less than or equal to a first distance from the stringing apparatus, the controller can be further configured to output an alarm. In response to determining that the person is less than or equal to a second distance from the stringing apparatus, the controller can be further configurated to output a control signal to stop the driveline. The second distance can be less than the first distance.

The machine monitor can be a photoelectric sensor.

The stringing apparatus can further include an energy bank and an electric motor configured to receive electric power from the energy bank and to drive the driveline.

The stringing apparatus can further include a temperature sensor that is configured to detect a temperature of the energy bank and output temperature data indicative of the temperature of the energy bank. The control system can be further configured to receive the temperature data from the temperature sensor and, in response to determining that the temperature of the energy bank is less than or equal to a minimum threshold temperature, output a control signal to limit an output of the energy bank. In response to determining that the temperature of the energy bank is greater than or equal to a maximum threshold temperature, the control system can be further configured to output a control signal to limit an output of the energy bank.

The energy bank can be a first energy bank and the stringing apparatus can further include a first port configured to electrically connect the first energy bank to the stringing apparatus, a second energy bank, and a second port configured to electrically connect the second energy bank to the stringing apparatus.

The control system can be further configured to determine whether the first energy bank is electrically connected to the first port and whether the second energy bank is electrically connected to the second port.

The control system can be further configured to determine an output capacity of the first energy bank and the second energy bank, respectively. In response to determining that the output capacity of the first energy bank is sufficient to meet an energy demand of the electric motor to drive the driveline, the control system can be configured to electrically connect only the first energy bank to the electric motor.

In response to determining that the output capacity of the first energy bank is insufficient to meet the energy demand of the electric motor to drive the driveline, the control system can be configured to electrically connect both the first energy bank and the second energy bank to the electric motor.

The stringing apparatus can further include a plurality of lights. The control system can be further configured to determine a charge level of the energy bank and output a control signal to cause one or more of the plurality of lights to illuminate indicative of charge level of the energy bank.

The control system can be further configured to output a control signal to the plurality of lights to cause one or more of the plurality of lights to change a color of the one or more lights. The color can be indicative of a status of the stringing apparatus.

The stringing apparatus can further include an engine and a generator to convert power from the engine into electric power, the generator being electrically connected to the electric motor.

The disclosed technology can further include a stringing apparatus having an engine, a generator to convert power from the engine into electric power, and an electric motor configured to drive a driveline. The driveline can be configured to receive a cable. The stringing apparatus can further include a control system configured to, in response to determining that the engine is operating, output a first control signal to cause the generator to electrically connect to an external load. The control system can be further configured to output a second control signal to cause the generator to electrically connect to the electric motor to drive the driveline in a pulling mode.

In response to determining that the electric motor is driving the driveline, the control system can be further configured to output a third control signal to electrically disconnect the generator from the external load.

In response to receiving a stop signal to stop the electric motor from driving the driveline, The control system can be further configured to output a fourth control signal to cause the generator to electrically connect to the external load.

The disclosed technology can include a stringing apparatus comprising a driveline configured to receive a cable, an energy bank, an electric motor configured to receive electric power from the energy bank and to drive the driveline, a temperature sensor configured to detect a temperature of the energy bank and output temperature data indicative of the temperature of the energy bank, and a control system.

The control system can be configured to receive the temperature data from the temperature sensor and, in response to determining that the temperature of the energy bank is less than or equal to a minimum threshold temperature, output a control signal to limit an output of the energy bank.

In response to determining that the temperature of the energy bank is greater than or equal to a maximum threshold temperature, the control system can be configured to output a control signal to limit an output of the energy bank.

The energy bank can be a first energy bank and the stringing apparatus further include a first port configured to electrically connect the first energy bank to the stringing apparatus, a second energy bank, and a second port configured to electrically connect the second energy bank to the stringing apparatus.

The control system can be further configured to determine whether the first energy bank is electrically connected to the first port and whether the second energy bank is electrically connected to the second port.

The control system can be further configured to determine an output capacity of the first energy bank and the second energy bank, respectively. In response to determining that the output capacity of the first energy bank is sufficient to meet an energy demand of the electric motor to drive the driveline, the control system can be further configured to electrically connect only the first energy bank to the electric motor.

The control system can be further configured to, in response to determining that the output capacity of the first energy bank is insufficient to meet the energy demand of the electric motor to drive the driveline, electrically connect both the first energy bank and the second energy bank to the electric motor.

The stringing apparatus can further include a plurality of lights. The control system can be configured to determine a charge level of the energy bank and output a control signal to cause one or more of the plurality of lights to illuminate indicative of charge level of the energy bank.

The control system can be further configured to output a control signal to the plurality of lights to cause one or more of the plurality of lights to change a color of the one or more lights, the color being indicative of a status of the stringing apparatus.

The stringing apparatus can be configured to receive a plurality of energy banks interchangeably.

The disclosed technology can include a stringing apparatus comprising a driveline configured to receive a cable, an energy bank, an electric motor configured to receive electric power from the energy bank and to drive the driveline, a machine monitor configured to detect a presence of a person near the stringing apparatus, and a control system. The control system can be configured to control an output of the electric motor based on the detected presence.

The machine monitor can be further configured to detect a distance between the person and the stringing apparatus.

In response to determining that the person is less than or equal to a first distance from the stringing apparatus, the control system can be further configured to output a control signal to reduce a speed at which the electric motor is driving the driveline.

In response to determining that the person is less than or equal to a first distance from the stringing apparatus, the control system can be further configured to output an alarm.

In response to determining that the person is less than or equal to a second distance from the stringing apparatus, the control system can be further configurated to output a control signal to stop the driveline, the second distance being less than the first distance.

The stringing apparatus can further include a removable control console. The removable control console can be in wireless communication with the stringing apparatus and be configured to remotely control the stringing apparatus.

The stringing apparatus can include a docking port configured to receive the removable control console.

The system further can include a memory having instructional videos stored thereon. The instructional videos can be videos of instructions for operating the stringing apparatus.

The control system can be configured to receive and process voice commands from an operator of the stringing apparatus.

These and other objects, features and advantages of the present invention will become more apparent upon reading the following specification in conjunction with the accompanying drawing figures.

### BRIEF DESCRIPTION OF THE DRAWINGS

The accompanying figures, which are incorporated in and constitute a part of this specification, illustrate several aspects described below.

FIG. 1 depicts conductor installation with a pair of stringing equipment.

FIG. 2 is a side view of an example stringing equipment.

FIG. 3 is a block diagram of an example power assembly and control system.

FIG. 4 is a flowchart of an example conductor installation method.

FIG. 5 is a flowchart of an example conductor installation method.

FIG. 6 is a flowchart of an example conductor installation method.

FIG. 7 is a side view of example stringing equipment.

FIG. 8A is a front perspective view of an example stringing equipment.

FIG. 8B is a rear perspective view of an example stringing equipment.

FIG. 9 is a front view of levelwinds of an example stringing equipment.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Furthermore, although the various methods may be shown and described herein as having a particular order, it will be appreciated by one of skill in the art that the method steps shown and described can be rearranged in various other orders without departing from the scope of this disclosure. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Examples of the present disclosure can comprise stringing equipment for stringing wires, pulling lines, ropes, cables, cords, and the like (collectively, “cables”). The system can comprise an engine coupled to a generator, which drives a motor and can charge a battery bank, a capacitor bank, or both (“energy bank” or “battery/capacitor bank”). The energy bank, likewise, can provide power to the motor as needed.

During tensioning, the motor provides resistance to the rotation of a driveline (cable drum or reel) to provide tension to the line for proper stringing conditions. When providing resistance, the motor can return energy to be stored in the energy bank. When the power generated, or the rate of power generated, is greater than can be absorbed by the energy bank, a resistor bank can be used to dissipate excess power.

In some cases, the engine can be a combustion engine that may provide additional resistance to counteract any excess pull. During pulling, on the other hand, the motor (powered by the energy bank, as needed) turns a drum that pulls the line for installation. In some cases, however, more power is needed for installation than can be provided by the generator or energy bank alone. In this case, the generator may be used to pre-charge the energy bank to enable both the generator and the energy bank to be used in unison to provide additional power to the motor than can be provided by either source alone.

In other situations, the combustion engine can be directly mechanically communicative to the driveline, assisting the motor or altogether bypassing the need for the motor in specific situations.

Examples of the present disclosure may include additional energy sources and stores. For example, the system can be adapted to receive power from an external power source (e.g., by plugging into an external generator or the power grid). The external power can directly power the motor, charge the battery/capacitor bank and other systems. The external power can include additional energy stores that can be connected to the stringing equipment to charge the onboard energy store or to provide additional power to the stringing equipment during a pulling operation.

In an embodiment, the stringing equipment may include a kinetic energy store (e.g., a flywheel). The kinetic energy store may be driven during tensioning if the battery and/or capacitor bank are unable to absorb all of the energy produced. When the energy to be absorbed is reduced, the stringing equipment may then utilize the kinetic energy store to charge the energy bank.

In some examples, the stringing equipment can include a notification unit that can have lights and/or an audible alarm that can provide information to an operator such as energy store level, critical warnings, etc. The stringing equipment can further include temperature sensors that can output temperature data indicative of the temperature of the energy store and the controller can take actions based on the temperature.

The stringing equipment can further include one or more levelwinds that can be configured to ensure the cable is properly distributed on the reel. The levelwinds can be configured to operate in a synchronous mode or in an asynchronous mode.

The stringing equipment can include a fully-integrated machine monitor (FIMM) that can be configured to detect the position of people near the stringing equipment or various components on the stringing equipment. The controller can receive data from the FIMM and stop or slow the driveline if a person approaches the stringing equipment. The controller can additionally use the data received from the FIMM to control the levelwinds and the driveline.

In some examples, the stringing equipment can be configured to pre-load the engine before applying a load from the driveline to help prevent damage to the engine and to reduce large variations in voltage.

For ease of explanation, the system is discussed below with reference to stringing and supporting power and communications lines. One of skill in the art will recognize, however, that the system is not so limited. Indeed, the system could be used in any number of industries where ropes, support cables (e.g., for ski lifts), communications cables, wires, and other similar products need to be efficiently installed and supported. Thus, the description below is intended to be illustrative and not limiting.

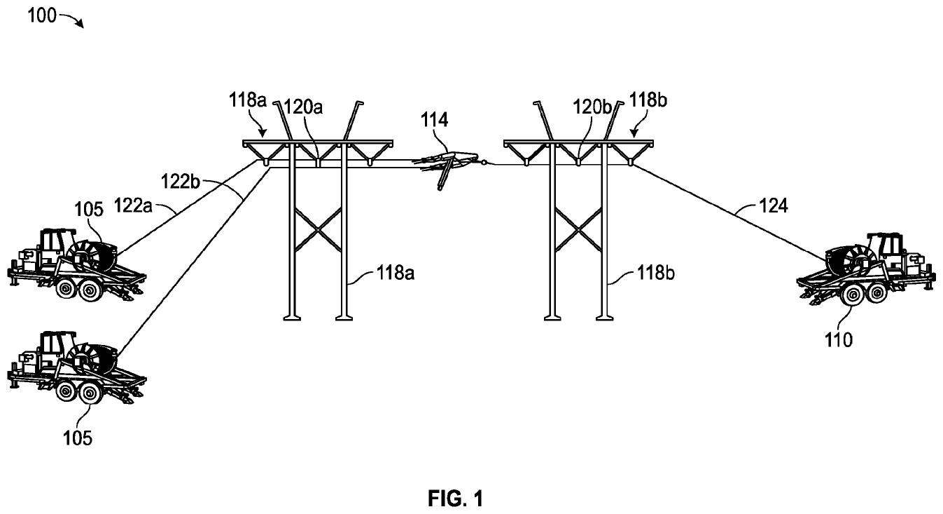

FIG. 1 illustrates an example of conductor installation system 100. Two different stringing equipment 105 and one stringing equipment 110 are situated at opposite ends of a span for installation. In some embodiments, the system 100 includes two tensioners 105, a running board 114, a puller 110, power transmission towers/poles 118a, 118b, one or more blocks 120a, 120b associated with each power transmission pole, conductors 122a, 122b, and a pulling line 124.

The puller 110 pulls a pulling line 124 connected to the conductors 122a, 122b through the running board 114. Meanwhile, tensioners 105 provides tension on the conductors 122a, 122b to limit improper sagging of the conductors 122a, 122b as they are pulled across poles 118a, 118b.

In some applications, the power transmission towers/poles 118a, 118b extend over a distance of multiple miles (e.g., 4-5 miles). Prior to the installation, pulling line 124 is extended and strung through the blocks (e.g., 120a, 120b) associated with each of the power transmission towers/poles 118a, 118b.

The running board 114 is connected on one side to the pulling line 124 at a location near to tensioner 105. The conductors 122a, 122b to be installed are connected to the other side of the running board 114. At this point in the conductor pull operation, the running board is pulled through the blocks 120a, 120b associated with each of the power transmission towers/poles 118a, 118b, thereby installing the conductors into place along the blocks and spanning the distance between the puller 110 and the tensioners 105.

More particularly, the puller 110 includes a motor that provides a pulling force to pulling line 124. The tensioners 105 apply an opposite force (e.g., a tensioning force) that opposes the pulling force applied to pulling line 124 to maintain tension in the conductors 122a, 122b while allowing the conductors to be pulled through the blocks towards the puller 110. In some embodiments, the tensioners 105 apply tension separately to each conductor 122a, 122b being pulled.

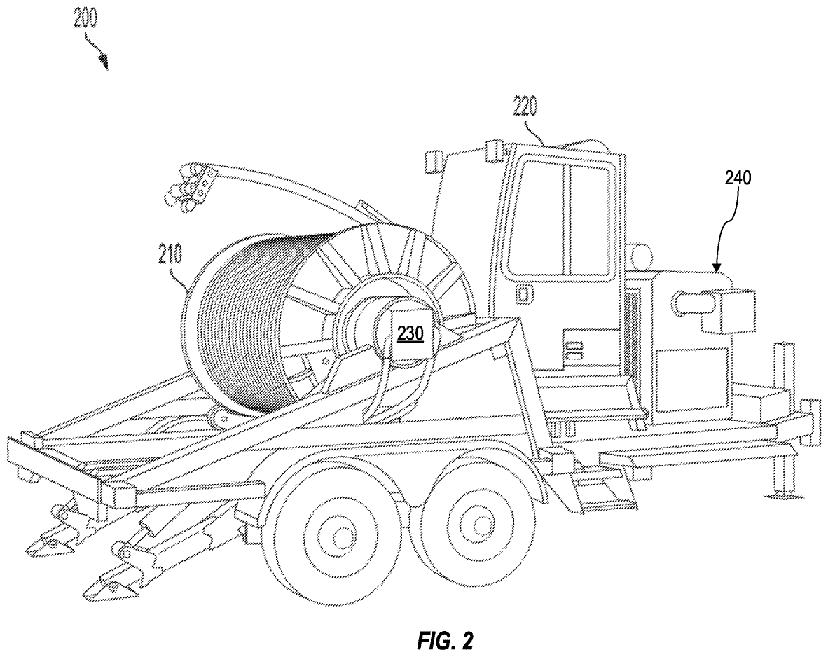

FIG. 2 illustrates an exemplary stringing equipment 200. Stringing equipment 200 includes a driveline 210 (a drum, bull wheel, spool, reel, driveline or the like), a console 220, a motor/generator 230, and a power assembly 240. Driveline 210 may be turned during conductor installation, either by unraveling a conductor 122a wrapped around it (when used for tensioning) or to wrap a pulling line 124 and/or pulling a conductor 122a (when used for pulling).

Console 220 may include controls for the stringing equipment. The controls may operate the motor, selectively control tensioning or pulling, and/or select from the various power sources. In some cases, the controls may instruct the generator to charge the battery or another energy store in order to provide greater power to the motor (e.g., so that the generator and battery may provide power to the motor in unison). Power assembly 240 provides power to driveline 210.

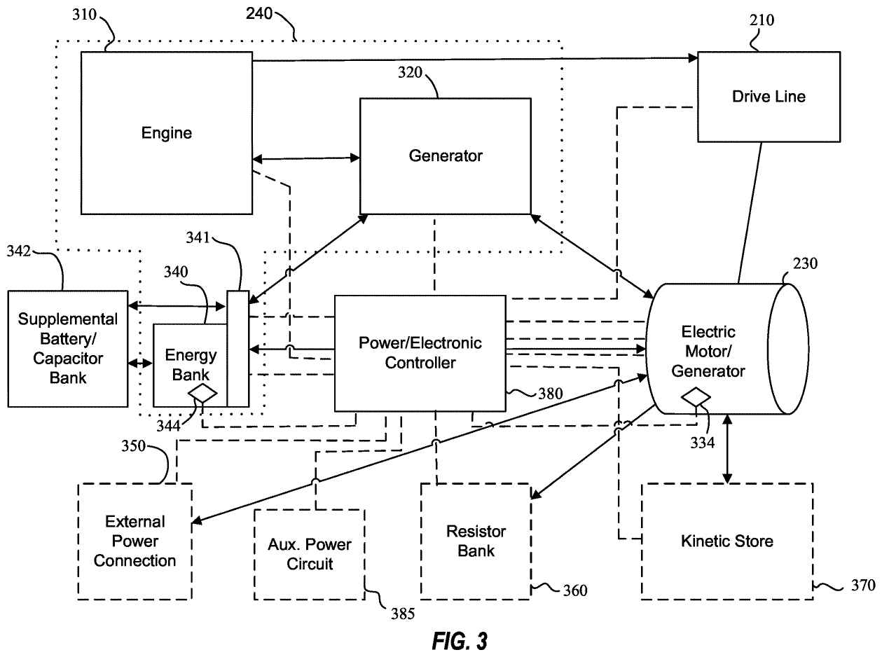

FIG. 3 is a block diagram of various components with the power assembly 240 and the control system 380 (or controller 380). The power assembly 240 can comprise a first source of electric power 340 and a second source of electric power 320 different than the first source, each of the first source 340 and the second source 320 configured to provide, on its own, sufficient power to operate a motor/generator 230 for a driveline 210 associated with a stringing operation of one or more conductors, wherein the stringing operation comprises driving the driveline 210 in a pulling mode and resisting the driveline 210 in a tensioning mode.

Power assembly 240 includes an engine 310, a generator 320, and an energy bank 340 (sometimes referred to herein as energy bank 340). Motor/generator 230 operates driveline 210, either by controlling driveline 210 to turn (e.g., during a pulling operation), or by resisting the turning of driveline 210 (i.e., in a tensioning operation). Motor/generator 230 may receive power from generator 320 and/or energy bank 340. Generator 320 generates electric power from engine 310 and provides the power to energy bank 340 and/or motor/generator 230. Energy bank 340 can include a battery bank and/or a capacitor bank configured to store electrical energy and provide electrical energy to the motor/generator 230. Unless explicitly stated or the context clearly dictates otherwise, the energy bank 340 as described herein can include a single battery or capacitor or the energy bank 340 can include multiple batteries or multiple capacitors connected together to form a single unit.

During a pulling operation, engine 310 may be run to generator 320. The power from generator 320 may be provided to motor/generator 230 to rotate driveline 210. In some cases, generator 320 may provide more power than is needed by motor/generator 230. In this case, excess power from generator 320 may be provided to energy bank 340 to charge energy bank 340. In some cases, generator 320 may provide insufficient energy to power motor/generator 230. In such cases, energy bank 340 may be used to provide power to motor/generator 230. In some instances, generator 320 may first charge energy bank 340 and then, together with energy bank 340, provide increased power to motor/generator 230. In this manner, more power than can be provided from either source alone (i.e., generator 320 or battery bank 340) may be used to install the conductor. Of course, based on demand, power can also be provided only from energy bank 340 or the generator 320.

As will be appreciated, the energy bank 340 can be sized to meet the energy demand expected for the particular pulling operation. For example, the energy bank 340 can have a first capacity for a pulling operation in which the cable extends a first distance and, in the case where the cable must be pulled a second distance that is greater than the first distance, the energy bank 340 can be replaced with an energy bank 340 having a greater capacity. Alternatively, or in addition, the power assembly 240 can be adapted for receiving multiple energy banks 340 such that the power assembly 240 can be modified or configured to meet the tension demands of the particular pulling operation. For instance, the stringing equipment 200 can be configured to receive and support multiple energy banks 340 for a pulling operation requiring a greater tension.

When multiple energy banks 340 are connected, the energy banks 340 can be configured to have one of the energy banks 340 assigned to be a parent energy bank while the second energy bank 340 can be a child energy bank. The control system 380 can communicate with the parent energy bank 340 and the parent energy bank 340 can communicate with the child energy bank 340. Alternatively, the control system 380 can be configured to communicate with each energy bank 340 individually without having a parent/child relationship assigned between energy banks 340. As will be appreciated, if each energy bank 340 can communicate directly with the control system 380, each energy bank 340 can be replaced individually while other connected energy banks 340 remain in communication with the control system 380.

The power assembly 240 can be further configured for easily changing or modifying the energy bank 340, even while the stringing equipment 200 is in use (sometimes referred to as “hot swapping”). In other words, the power assembly 240 can be configured such that an energy bank 340 can be replaced with another energy bank 340 while the stringing equipment 200 is operating. As an example, if it is determined that the energy bank 340 is nearly depleted, the motor/generator 230 can be operated using the engine 310 and the generator 320. The energy bank 340 can then be electrically disconnected so that the nearly-depleted energy bank 340 can be replaced with a fully-charged energy bank 340. In some examples, the control system 380 can automatically perform the foregoing actions or an operator can manually perform the foregoing actions to replace the connected energy bank 340. For example, the stringing equipment 200 can have more than one energy bank 340 installed and the control system 380 can be configured to actuate a switch or breaker to automatically disconnect a depleted or nearly depleted energy bank 340 and connect a charged energy bank 340. Alternatively, an operator can install a new energy bank 340 or similarly actuate a switch or breaker to switch from the depleted or nearly depleted energy bank 340 to a charged energy bank 340. Furthermore, the engine 310 and the generator 320 can be connected to the depleted or nearly depleted energy bank 340 to begin recharging the depleted or nearly depleted energy bank 340 when the charged energy bank 340 is being used to operate the motor/generator 230.

As another example of hot swapping the energy bank 340, the control system 380 can be configured to monitor the capacity of the energy bank 340 and, if the energy bank 340 is nearly depleted, the control system 380 can output an alarm or notification to notify an operator that the nearly-depleted energy bank 340 should be replaced with a charged energy bank 340. The operator can then connect an additional energy bank 340 to the power assembly 240 and the operator or the control system 380 can electrically connect the charged energy bank 340 to the motor/generator 230 and disconnect the nearly-depleted energy bank 340. In other examples, the power assembly 240 can have more than a single energy bank 340 and use only a single energy bank 340 at a time. In this way, either an operator or the control system 380 can cause the power assembly 240 to switch between energy banks 340 as one becomes depleted.

The energy bank 340 and/or the control system 380 can be configured to determine which port an energy bank 340 is connected to if there are multiple ports to which an energy bank 340 can be connected. As will be appreciated, by having more than one port or connection by which an energy bank 340 can be connected to the power assembly 240, the stringing equipment 200 can be configured to receive power from multiple energy banks 340. The energy bank 340 can include a controller or chip that is configured to output an address assigned to that energy bank 340 to the controller 380. The address can be preinstalled on the energy bank 340 (i.e., each energy bank 340 can have its own assigned address when manufactured) and the control system 380 can receive the preinstalled address from the energy bank 340. In some examples, the control system 380 can receive data indicative of which port a particular energy bank 340 is connected to. The control system 380 can determine which port the energy bank 340 is connected to by receiving data from a sensor near that particular port (e.g., a weight sensor or a presence sensor configured to detect the presence of an energy bank 340 in a specific location which is assigned to a particular port) and determining which energy bank 340 was connected (i.e., by the address) at the time the sensor determined the presence of the energy bank 340. Alternatively, the control system 380 can read the address of the connected energy bank 340 and determine which port it is connected to based on which port received the address data from the energy bank 340.

In some examples, the address can be dynamically updated by the controller on the energy bank 340 based on which port of the power assembly 240 the energy bank 340 is connected to. For example, if the energy bank 340 has more than one port configured to be connected to an energy bank 340, the controller on the energy bank 340 can update its address based on which port it was connected to. For example, the controller on the energy bank 340 can add a number to the end of its address which corresponds to the port that the energy bank 340 was connected to (i.e., if the energy bank 340 was connected to port number 4, the controller on the energy bank 340 can add a 4 to the end of its address to indicate that it is connected to port 4). As will be appreciated, various other methods can be used to determine which port a particular energy bank 340 is connected to.

By being able to detect the presence and location of each connected energy bank 340, the control system 380 can determine actions based on detected characteristics of each connected energy bank 340. As a non-limiting example, the control system 380 can track the charge levels of each connected energy bank 340 and determine whether to use, disconnect, and/or charge each connected energy bank 340. To illustrate, if the stringing equipment has four ports to which energy banks 340 can be connected, the control system 380 can determine that the energy banks 340 connected to ports 1 and 2 are nearly depleted and that the energy banks 340 connected to ports 3 and 4 have sufficient charge. In this example, the control system 380 can determine that the energy banks 340 connected at ports 3 and 4 should be used to power the motor/generator 230 and that the energy banks 340 connected at ports 1 and 2 should be charged with the engine 310 and generator 320. The control system 380 can then output a notification to the operator to make the necessary adjustments or can output instructions to a switching device 341 to automatically connect energy banks 340 at ports 3 and 4 to the motor/generator 230 and connect energy banks 340 at ports 1 and 2 to the generator 320.

As another example, the control system 380 can determine which energy banks 340 should be used for particular tasks and automatically switch between using specific energy banks 340 for a given task. For example, if the control system 380 determines that the particular task does not require a lot of current to drive the motor/generator 230 and that a single energy bank 340 can output the required current, the control system 380 can output instructions to a switching device 341 to automatically disconnect all energy banks 340 except for one energy bank 340. In contrast, if the control system 380 determines that the task will require more current to drive the motor/generator 230 than can be provided by a single energy bank 340, the control system 380 can output instructions to a switching device 341 to connect as many energy banks 340 are required for the particular task.

As another non-limiting example, each connected energy bank 340 can include a temperature sensor 344 (as described in greater detail herein) and the controller 380 can determine the temperature of each respective energy bank 340 based on temperature data received from the respective temperature sensors 344. If one of the energy banks 340 has begun to overheat, the controller 380 can output a warning to notify the operator which specific energy bank 340 is overheating. The controller 380 can further be configured to output instructions to a switching device 341 to disconnect the energy bank 340 that is overheating and connect a different energy bank 340 to continue operation of the stringing equipment 200 without interruption. As will be appreciated, disconnecting the overheated energy bank 340 can permit the overheated energy bank 340 to cool down while not in use.

In some examples, a supplemental energy bank 342 (e.g., a supplemental battery or capacitor bank) that is separate from the stringing equipment 200 can be connected to the energy bank 340 or to the switching device 341 to provide additional power to the energy bank 340 or to the motor/generator 230. The supplemental energy bank 340, for example, can be mounted on a trailer, a skid, a truck, or other portable or mobile unit and electrically connected to the energy bank 340. This can be helpful, for example, if the stringing equipment 200 is used in a pulling operation in a remote location or otherwise in a location where grid power is unavailable. Furthermore, the supplemental energy bank 342 can be used, for example, to provide additional power to the motor/generator 230 during a pulling operation where higher tension is expected. In some examples, the supplemental energy bank 340 can be installed in series to provide power to the energy bank 340 which, in turn, can provide power to the motor/generator 230. Alternatively, the supplemental energy bank 340 can be installed in parallel with the energy bank 340 to provide additional power directly to the motor/generator 230. The power assembly 240 can be further configured to charge the depleted energy bank 340 using the generator 320 or an external power connection 350 while the energy bank 340 is still providing energy to the motor/generator 230. For example, as the energy bank 340 depletes during a pulling operation, the generator 320 can be powered by the engine 310 to charge the energy bank 340 to ensure the energy bank 340 maintains sufficient capacity while the energy bank 340 simultaneously provides power to the motor/generator 230. Alternatively, or in addition, the energy bank 340 can be charged by an external power connection 350. In some examples. The external power connection 350 can be utility grid power, a renewable power source such as wind or solar, a rapid charging station, or other external power sources. In some examples, the stringing equipment 200 can be transported to a rapid charging station and connected to a rapid charging station to charge the energy bank 340.

In some implementations, motor/generator 230 may receive power from an external power connection 350. For example, motor/generator may have a 240V connector and be configured to connect with an external power source (e.g., an external generator or the power grid). In this case, power may be provided to motor/generator 230 from any combination of generator 320, energy bank 340, and external power connection 350.

In some examples, the power assembly 240 can be include an auxiliary power circuit 385 that can be configured to provide power to various auxiliary units. The auxiliary power circuit 385 can include, for example and not limitation, a 120-volt, a 48-volt, or a 12-volt circuit that is configured to provide power to various electrical equipment such as power tools, lights, computers, etc. In this way, the power assembly 240 can be used for providing power to tools or devices that are necessary for completing a pulling or tensioning operation. Similarly, the 48-volt and 12-volt circuits can be configured to provide a charge to other connected batteries or energy banks of equipment used with the stringing equipment 200. As will be appreciated, this can be particularly helpful in locations where grid power or other power sources are unavailable. In some examples, the 48-volt and 12-volt circuits can be configured such that both circuits can be locked-out/tagged-out with a single lock or tag.

During a tensioning operation, motor/generator 230 provides resistance to the turning of driveline 210 to provide tension to the conductor line. The energy generated by motor/generator 230 during tensioning can be used to charge energy bank 340 or supplemental energy bank 342. When energy bank 340 or supplemental energy bank 342 cannot store all of the energy produced (i.e., because it is fully charged or because the rate of energy production exceeds the charging rate of energy bank 340), generator 320 and/or engine 310 may be used to absorb some of the energy. The generator 320 can be used to turn over the engine 310, for example, to use the compression of the engine 310 to dissipate excess energy. Additionally, excess energy may be provided to external power connection 350 to enable the grid to absorb the energy and/or to dissipate energy within the external generator. In some implementations, a resistor bank 360 may also be provided for excess energy dissipation.

Excess heat produced by the resistor bank 360 may be dissipated with a heat sink and/or fan, or used to heat other components of the power assembly 240. Excess/waste heat can also be used to heat and/or cool on-board systems, like area(s) in proximity to the operator. This heat can be used to provide air-conditioning when needed, and heating when needed, to provide operator comfort.

In some implementations, power assembly 240 may further include a kinetic energy store 370, such as a flywheel. In this configuration, the excess energy generated during tensioning may be used to charge the kinetic energy store 370. The kinetic energy store 370 may later be used to turn the generator 320, for example, to charge the energy bank 340. In some cases, a connection with kinetic energy store 370 may be bi-directional to enable excess energy to “charge” the kinetic energy store 370 (e.g., spin the flywheel), for example, and then use the stored kinetic energy in the flywheel to recharge the energy bank 340.

Control system 380 may be used to selectively control one or more of any components of the present invention. The various components can be communicative with the control system 380 via a number of ways, including wirelessly and wired. The components themselves can have autonomous control, outside of a “central” control system 380, for example, to monitor component features unique to that component, or in order to take actions in view of local control command.

For example, control system 380 may be used to selectively control the energy sources (e.g., engine 310, generator 320, energy bank 340, external power connection 350, and kinetic energy store 370) based on power consumption and/or storage rate. For example, the control system 380 may adjust a throttle for engine 310 and/or draw energy from energy bank 340 based on the current demand of motor/generator 230. Similarly, the control system 380 may control a flow of energy from motor/generator 230 to the various sinks (e.g., engine 310, generator 320, energy bank 340, external power connection 350, resistor bank 360, and kinetic energy store 370) based on the state of the various components of power assembly 240 (e.g., based on a state charge of the energy bank 340, the temperature of the resistor bank 360, etc.). By combining hybrid power generation and dissipation systems, examples of the present disclosure provide increased power, greater adaptability, and enable the use of smaller engines, smaller generators, and smaller energy banks to achieve the same energy inputs and outputs.

In some examples, the power assembly 240 can include a temperature sensor 334 disposed on or near the motor/generator 230 and a temperature sensor 344 disposed on or near the energy bank 340. The temperature sensors 334, 344 can be configured to detect a temperature of the energy bank 340 and output temperature data to the control system 380. The control system 380 can determine actions based on the received temperature data. For example, the control system 380 can determine that the temperature of the energy store 340 is less than a minimum threshold temperature. If the temperature of the energy store 340 is less than the minimum threshold temperature, it can be indicative of the energy store 340 being unable to output power at a full output capacity. For example, if the energy store 340 is at a temperature less than the minimum threshold temperature, the energy store 340 may be damaged if too great of a load is placed on it. In this instance, the control system 380 can reduce the output of the stringing equipment 200 to ensure the load on the energy store 340 remains below the load wherein the energy store 340 may be damaged.

As the temperature of the energy store 340 rises, the control system 380 can determine that the temperature of the energy store 340 is greater than or equal to the threshold temperature and permit the stringing equipment 200 to perform the pulling operation at the full capacity of the energy store 340. As will be appreciated, when the temperature of the energy store 340 is greater than or equal to the threshold temperature, the energy store 340 is less like to be damaged if the stringing equipment 200 is operated at full capacity.

The control system 380 can further determine that the temperature of the energy store 340 or the motor/generator 230 is greater than a maximum threshold temperature and output a control signal to reduce the output or shutoff the stringing equipment 200 to prevent the energy store 340 or the motor/generator 230 from overheating. As will be appreciated, many energy stores 340 (e.g., batteries, capacitors, etc.) and motors/generators 230 can become damaged if they become too hot. By reducing the output of the stringing equipment 200 or altogether shutting down the stringing equipment 200, damage to the energy store 340 and/or the motor/generator 230 can be reduced or prevented. In some examples, the stringing equipment 200 can switch over to using the engine 310 and the generator 320 to provide power to the motor/generator 230 instead of the energy store 340 to prevent damage to the energy store 340 and to continue the pulling operation (or tensioning operation as the case may be).

Control system 380 can integrate the operation of the driveline of a puller during a stringing operation, comprising driving the driveline in a pulling mode of the stringing operation during a pulling period, and selectively driving the driveline in the pulling mode among at least a parallel configuration, a series configuration, and/or a series-parallel configuration.

In the parallel configuration, a motor located on the stringing equipment and an engine located on the stringing equipment can both individually drive the driveline or both can jointly drive the driveline, the motor having a first source of power comprising a battery/capacitor bank.

In the series configuration, the motor individually drives the driveline, the motor having the first source of power and a second source of power, the first source of power comprising the battery/capacitor bank and the second source of power comprising a generator powered by the engine.

In the series-parallel configuration, the motor and engine can both individually drive the driveline or both can jointly drive the driveline, and the motor has the first source of power and the second source of power, the first source of power comprising the battery/capacitor bank and the second source of power comprising the generator powered by the engine.

Control system 380 can integrate the operation of the driveline of a stringing equipment 200 during a stringing operation comprising driving the driveline 210 in a pulling mode of the stringing operation during a pulling period, resisting the driveline 210 in a tensioning mode of the stringing operation during a tensioning period, and selectively driving the driveline 210 in the pulling mode among at least a parallel configuration, a series configuration, and/or a series-parallel configuration.

In the parallel configuration, a motor/generator 230 located on the stringing equipment 200 and an engine 310 located on the stringing equipment 200 can both individually drive the driveline 210 or both can jointly drive the driveline 210, the motor/generator 230 having a first source of power comprising a battery/capacitor bank (energy store 340).

In the series configuration, the motor/generator 230 individually drives the driveline 210, the motor/generator 230 having the first source of power and a second source of power, the first source of power comprising the battery/capacitor bank (energy store 340) and the second source of power comprising a generator 320 powered by the engine 310.

In the series-parallel configuration, the motor/generator 230 and engine 310 can both individually drive the driveline 210 or both can jointly drive the driveline 210, and the motor/generator 230 has the first source of power and the second source of power, the first source of power comprising the battery/capacitor bank (energy store 340) and the second source of power comprising the generator 320 powered by the engine 310.

Control system 380 can integrate the operation of the driveline 210 of stringing equipment 200 during a stringing operation comprising driving the driveline 210 in a pulling mode of the stringing operation by a motor/generator 230 during a pulling period, wherein the motor/generator 230 is powered by a first source of power, resisting the driveline 210 in a tensioning mode of the stringing operation by the motor/generator 230 during a tensioning period, and intelligently controlling the driving and resisting.

The first source of power comprises a battery/capacitor bank (energy store 340), and at least a portion of energy produced during the resisting is stored in the battery/capacitor bank.

Intelligently controlling can comprise determining an amount of the stringing operation completed, determining an amount of the stringing operation left to be completed, monitoring a current capacity of the first power source, determining if the current capacity of the first power source and the added capacity from one or more tensioning periods in the amount of the stringing operation left to be completed is sufficient to power the motor during one or more pulling periods in the amount of the stringing operation left to be completed, changing one or more driving characteristics and resisting characteristics to extend the use of the first source of power to complete as much of the stringing operation before battery/capacitor bank exhaustion.

Intelligently controlling can further comprise providing sufficient power to the driveline 210 from a second source of power different than the first if the battery/capacitor bank (energy store 340) will exhaust prior to completion of the stringing operation, and completing the stringing operation with the second source of power and/or augmenting the use of the battery/capacitor bank (energy store 340) with the second source of power to complete the stringing operation.

Intelligently controlling can further comprise providing sufficient additional power to the battery/capacitor bank so the battery/capacitor bank will not exhaust prior to completion of the stringing operation.

The present invention can further provide an operator with information related to the control of a driveline 210 of stringing equipment 200 during a stringing operation. The driving and resisting of the driveline 210 are monitored to determine if the capacity of the battery/capacitor bank (energy store 340) can complete the stringing operation. The operator is then provided with data sufficient to manage the driving and resisting, and the provision of any additional power needs to complete the stringing operation. The data can be displayed for the operator on, for example, a control panel in the console 220.

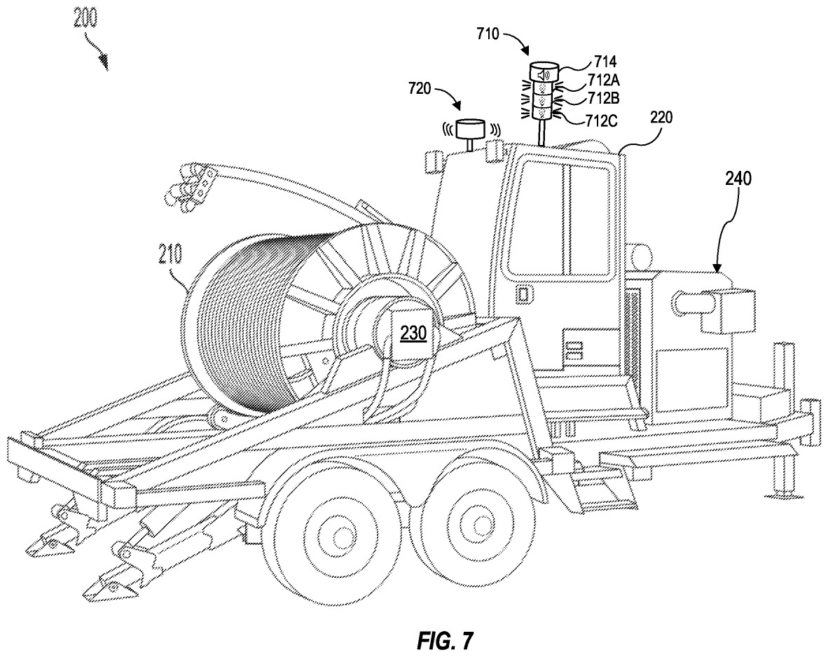

The present invention can include alerting the operator if the capacity of the battery/capacitor bank (energy store 340) cannot complete the stringing operation. For example, as illustrated in FIG. 7, the stringing equipment 200 can include a notification unit 710 that can be configured to provide the operator will information about the capacity of the energy store 340. For example, the notification unit 710 can include a first light 712A, a second light 712B, and a third light 712C (collectively, the lights 712ABC). The notification unit 710 can further include an audible alarm 714.

The lights 712ABC can be configured to output different colors of lights depending on the capacity of the energy store 340. For example, the lights 712ABC can each be green if the energy store 340 is fully charged and able to operate at full capacity. If the energy store 340 has a state of charge of between approximately 66%-100%, the first light 712A can be illuminated with a green color. The second light 712B and the third light 712C can also each be illuminated with a green color if the energy store 340 has a state of charge of between approximately 66%-100%. As another example, if the energy store 340 has a state of charge of between approximately 33%-66%, the first light 712A can be turned off and the second light 712B can be illuminated with a green color. In some examples, the third light 712C can also be illuminated with a green color if the energy store 340 has a state of charge of between approximately 33%-66%. As another example, if the energy store 340 has a state of charge of between approximately 0%-33%, the first light 712A and the second light 712B can each be turned off and the third light 712C can be illuminated with a green color. In some examples, at least one of the lights 712ABC can pulse or flash on and off when the energy store 340 is being used and discharging power. Furthermore, the lights 712ABC can turn different colors (such as yellow) when the energy store 340 is running low on energy. For example, if the energy store 340 is a battery and the battery is nearly depleted, at least the third light 712C can turn yellow when the battery is below a threshold charge level (e.g., 10%) to notify the operator that the energy store 340 is nearly depleted.

In other examples, the lights 712ABC can indicate other functions or statuses of the stringing equipment 200. For example, at least one of the lights 712ABC can pulse a different color (such as yellow) when the engine 310 is starting or the motor/generator 230 is beginning a pulling operation. As another example, the lights 712ABC can pulse together or in sequence or through different colors when the energy store 340 is charging. In other examples, all three of the lights 712ABC can turn yellow or a different color to indicate that the stringing equipment 200 is operating at a reduced capacity (limp home mode). This can occur, for example, when the energy store 340 is at a temperature that is less than the threshold temperature or greater than the maximum temperature (as described previously). As yet another example, all of the lights 712ABC can turn another color (such as red) when the stringing equipment 200 emergency stop is activated or a critical warning such as the energy store 340 or motor/generator 230 is overheated or the energy store 340 state of charge is approximately 0%.

As will be appreciated, the lights 712ABC can be arranged in various different orders, numbers, or configurations and can be configured to output various different colors or patterns of light depending on the particular application. Therefore, the example configuration of lights 712ABC provided herein are offered for illustrative purposes and should not be construed as limiting.

The notification unit 710 can further include an audible alarm 714 to provide additional notifications to the operator. For example, the audible alarm 714 can output a first sound or pattern of sounds when the engine 310 is starting, when the motor/generator 230 is starting a pulling or tensioning operation, when the energy store 340 is nearly depleted or is depleted, when the energy store 340 is overheated or the motor/generator 230 is overheated, or other critical or important warnings or notifications. The sound output from the audible alarm 714 can continue until the issue is addressed or the audible alarm 714 is turned off.

The control system 380 can incorporate the use of natural language control and/or alerts as the equipment is much less noisy without the engine running. In other words, because the stringing equipment 200 does not require an engine to be running during the entire stringing operation, the control system 380 can output audio notification and receive voice commands which was previously impractical with existing equipment. Various components of the present invention can be partially or completely controlled and/or monitored by voice, and alerts can be provided by a speaking voice or other audible means. For example, the disclosed technology can be configured to receive a voice command from an operator to begin or cease a pulling or tensioning operation. As another example, the disclosed technology can be configured to provide a report of various parameters or statuses of the stringing equipment 200. To illustrate, an operator can provide a voice command to the control system 380 to request the control system 380 provides a summary of the status of the energy store 340 level, the energy store 340 temperature, the length of cable paid out or pulled, etc. As will be appreciated, by incorporating a natural language control into the control system 380, the disclosed technology can be configured to provide information to an operator or to take actions based on an operator's voice command.

The control system 380 can further be configured to receive or store instructional videos, messages, recordings, etc. that can be accessed by an operator to learn how to operate or trouble shoot the stringing equipment 200. For example, the control system 380 can store a video that was previously recorded to instruct an operator how to perform a pulling or tensioning operation. The video can be displayed by the control system 380 on a display screen integrated into the control system 380 or on a connected device in communication with the control system 380 such as a connected computer, a connected tablet, a connected mobile device, etc. Further still, the control system 380 can be configured to send and receive wireless signals to receive and display instructional videos, messages, records, etc. from a remote server.

As will be appreciated, the control system 380 can be integrated into the console 220. The console 220 can be or include a cabin, an enclosure, or other operator station that an operator can enter or approach to access the control system 380 and operate the stringing equipment 200. The control system 380 can be a removable control console system that can be remote from the stringing equipment 200 and be configured to operate the stringing equipment remotely. For example, the control system 380 can be a removable control console including a screen and various controls (joystick/push buttons/rocker switches) for an operator to control the operation of the stringing equipment 200 remotely. The stringing equipment 200 may include a docking station to which the control system 380 can be docked to receive a charge and/or to control the stringing equipment 200. The control system 380 can be in wireless communication with the stringing equipment 200 such that an operator can remove the control system 380 from the docking station and walk to a remote location while still having the ability to control the stringing equipment 200. This can be useful, for example, if the operator needs to walk around the stringing equipment 200 to inspect the stringing equipment 200 during a stringing operation.

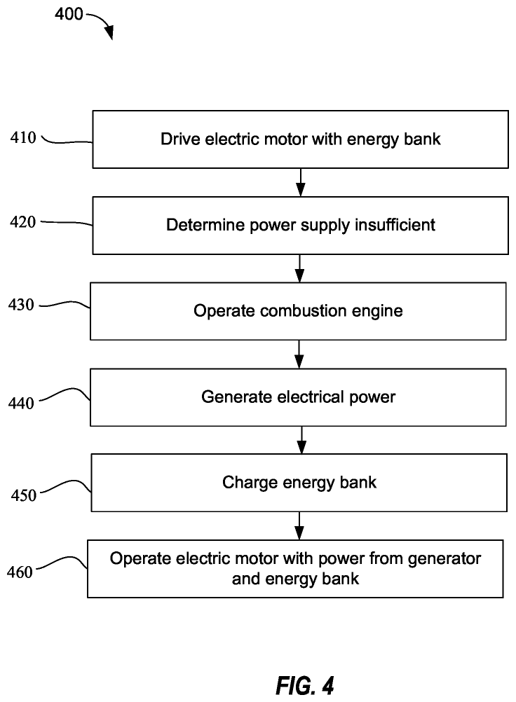

Returning now to FIG. 4, FIG. 4 is a flowchart of an example method 400 of operation of the stringing equipment 200. The method 400 may be controlled by the control system 380 of the stringing equipment 200. The method 400 can include driving 410 the motor/generator 230 with the energy bank 340. At 420, the control system 380 can determine that the power from the energy bank 340 is no longer sufficient to meet the needs of the motor/generator 230. As the cable is leaving and running through structures, the weight of the line means more tension. As the length of conductor 118 being pulled increases, for example, the tension required to maintain proper sag increases incrementally by the increased weight on installation sheaves, potentially exceeding the output capacity of the energy bank 340. Accordingly, at 430, the engine 310 is started and at 440, the operation of the engine 310 causes the generator 320 to generate power.

At 450, the power from the generator 320 can be used to charge the energy bank 340. Alternatively, or in addition, at 460 the power from the generator 320 can be used to drive the motor/generator 230 (i.e., to rotate the driveline 210) along with power from the energy bank 340. Accordingly, the combined power available to the motor/generator 230 is greater than can be provided from either the generator 320 or the energy bank 340 alone. As will be appreciated, the method 400 just described can be applicable, for example, if during a stringing operation the control system 380 determines that the power from the energy bank 340 alone is insufficient to drive the motor/generator 230. The control system 380 can then automatically start up the engine 310 to drive the generator 320 and charge the energy bank 340 and/or drive the motor/generator 230.

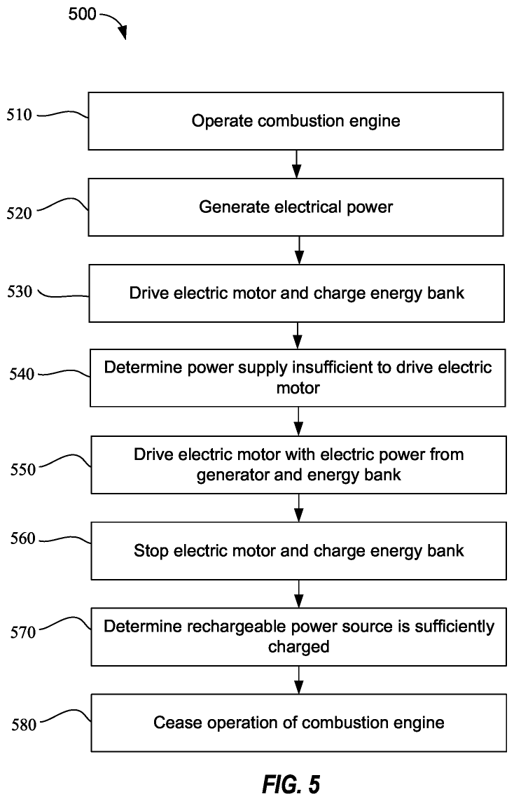

FIG. 5 is a flowchart of an example method 500 of operation of the stringing equipment 200. The method 500 may be controlled by the control system 380 of the stringing equipment 200. At 510, the engine 310 is started. At 520, the operation of the engine 310 causes the generator 320 to generate power. At 530, the power from the generator 320 is used to drive the motor/generator 230 (i.e., to rotate the driveline 210) and charge the energy bank 340 (e.g., charge a rechargeable energy store).

At 540, the control system 380 can determine that the power from the generator 320 is no longer sufficient to meet the needs of the motor/generator 230. As the length of conductor 122a/122b being pulled increases, for example, the friction caused by the increased weight on installation sheaves may increase, potentially exceeding the output capacity of the generator 320. Accordingly, at 550, the motor/generator 230 can be driven by power from both the generator 320 and power stored in the energy bank 340. Accordingly, the combined power available to the motor/generator 230 is greater than can be provided from either the generator 320 or the energy bank 340 alone.

At 560, the battery/capacitor bank may be stopped (e.g., after pulling the cabling elements/conductors 122a/122b is complete) and power from the generator 320 continue to be used to charge the energy bank 340. At 570, the control system 380 can determine that the energy bank 340 is charged to a predetermined level. This may be based on a set charge level (e.g., 70%, 80%, 100%, etc.) and/or a capacity of the energy bank 340. At 580, when sufficiently charged, the engine 310 may be stopped.

The present invention can further comprise telemetry elements, and can provide fine driving/tension control, virtually on-demand/instantly, with electric control over conventional hydraulic systems.

The stringing equipment 200 can be further configured to apply a simulated load on the engine 310 to help prevent damage to the engine 310 or large voltage swings when the engine 310 and generator 320 begin to drive the motor/generator 230. For example, the simulated load can be applied by the resistor bank 360, an electric-hydraulic pump, and/or a DC electric motor connected to the generator 320. The simulated load can be slowly applied to the engine 310 as the engine 310 warms up and reaches full output. As the engine 310 reaches full output, the load on the driveline 210 can be transitioned to the engine 310 to continue the pulling or tensioning operation. In this way, the engine 310 can be prevented from taking on too large of a load when the motor/generator 230 is connected to the generator 320 and driving the driveline 210.

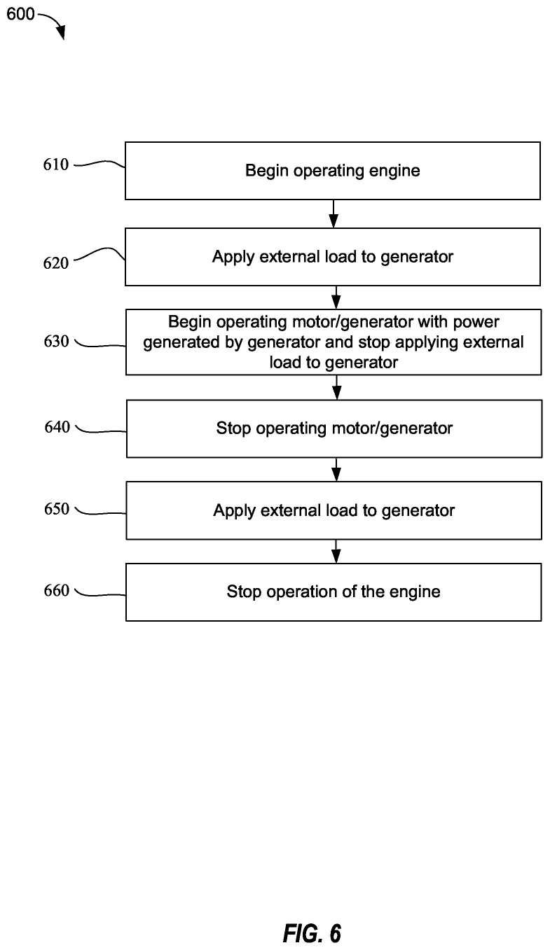

FIG. 6 flowchart of an example method 600 of operation of the stringing equipment 200. The method 500 may be controlled by the control system 380 of the stringing equipment 200. At 610 the engine 310 can be started and at 620 an external load can be applied to the generator 320. As will be appreciated, when an external load is applied to the generator through, for example, a resistor bank 360 and/or a DC electric motor, the load on the engine 310 will increase. As the load on the engine 310 increases, the revolutions per minute (RPMs) of the engine 310 will increase to handle the increased load.

At 630 the motor/generator 230 can begin to be operated by power generated by the generator 320 and the external load can be reduced or altogether removed. This transition can happen gradually to ensure a smooth transition is achieved to minimize voltage swings or spikes in the load carried by the engine 310. The motor/generator 230 can continue to be operated to complete the pulling operation. As will be appreciated by one of skill in the art with the benefit of this disclosure, the motor/generator 230 can be operated by power supplied from the energy bank 340 in addition to the power from the generator 320 to compensate for larger loads during the stringing operation.

The motor/generator 230 can be operated until the stringing operation is completed or until it is no longer necessary to continue operating the motor/generator 230. At 640 the motor/generator 230 can be stopped and at 650 the external load can once again be applied to the generator 320. As will be appreciated, the motor/generator 230 can be stopped more quickly than the engine 310 due to the inertial forces of the engine 310. Accordingly, if the motor/generator 230 were to be abruptly stopped without applying an external load to the generator 320, the generator 320 would produce a spike in voltage due to the sudden loss of load on the engine 310. Accordingly, by applying an external load to the generator 320, excessive voltage spikes can be avoided. As before, the transition between loading the generator 320 with the motor/generator 230 and the external load can be gradual to further help reduce voltage spikes. At 660 the engine 310 can be stopped.

Returning now to FIG. 7, the stringing equipment 200 can include a fully-integrated machine monitor 720 (FIMM) that can be configured to detect the position of various components of the stringing equipment 200 or objects near the stringing equipment 200. The FIMM 720 can replace the need for having multiple sensors as are currently used in existing stringing equipment. For example, existing stringing equipment commonly include position sensors, speed sensors, flow sensors, etc. to detect a status of various components and to output that information to a controller. The controller, in turn, determines a status of the stringing equipment and may determine actions based on the received inputs from the various sensors. The FIMM 720, in contrast, can be a sensor that gathers data about many components and objects simultaneously. For example, the FIMM 720 can be a vision system that can detect movement, position, size, etc. As a non-limiting illustrative example, the FIMM 720 can detect the presence of a person near the stringing equipment 200, the position of the cable on the driveline 210, the size of the cable on the driveline 210, and the speed of the driveline 210 simultaneously. In other words, the single FIMM 720 can perform functions that would have previously been accomplished with multiple sensors. Although described herein as including a single FIMM 720, one of skill in the art will appreciate that more than one FIMM 720 can be used to detect the position of objects or components on or near the stringing equipment 200 as necessary. However, as will be appreciated, even if more than one FIMM 720 is used on the stringing equipment 200, the FIMMs 720 can still be configured to reduce, or altogether replace, the sensors used on existing stringing equipment. Furthermore, although the FIMM 720 is shown in FIG. 7 as being positioned at a top of the console 220, the FIMM 720 can be positioned in any location on the stringing equipment 200 as suitable for the particular application.

The FIMM 720 can output data indicative of the various detected objects to the controller 380 and the controller 380 can determine actions based on the data received from the FIMM 720. The FIMM 720, for example, can be configured to detect the presence of a person near the stringing equipment 200. The FIMM 720 can be further configured to detect a distance between the stringing equipment 200 and the person and output data to the controller 380 indicative of the distance between the person and the stringing equipment 200. The controller 380 can determine whether the person is located in a danger zone or a warning zone depending on a distance between the person and the stringing equipment 200. The danger zone can be an area between the stringing equipment 200 and a first distance from the stringing equipment 200. The first distance can be in any direction from the stringing equipment 200 or in only predefined directions such that a predefined danger zone can be defined. The warning zone can be an area between the first distance and a second distance (e.g., the person can be positioned farther away from the stringing equipment 200 than when in the danger zone). The controller 380 can be configured to take actions based on whether the person is determined to be in the warning zone or in the danger zone. To illustrate, if the FIMM 720 detects the presence of a person in the danger zone (e.g., near the driveline 210 during a pulling or tensioning operation), the controller 380 can determine that the driveline 210 should be stopped to help prevent injury to the person. If the FIMM 720 detects the presence of a person in the warning zone, the controller 380 can determine that the driveline 210 should be slowed to help prevent injury to the person. Alternatively, or in addition, the controller 380 can output a warning (e.g., via the lights 712ABC and/or the audible alarm 714) to warn the person to leave the danger zone or to notify an operator of the potential danger. The warning can be different depending on whether the person is determined to be in the danger zone or the warning zone. As another example, the controller 380 can be configured to prevent startup of the driveline 210 until the person has left the danger zone. In some example, this feature can enable support staff or other operators to stop or slow the driveline 210 without needing to enter the console 220.

As another example, the FIMM 720 can be configured to detect a position of a levelwind (e.g., levelwind 812 as discussed further herein) of the driveline 210, a speed of the driveline 210, a size of the cable being pulled by the driveline 210, the reel diameter, engagement of the driveline 210, etc. In this way, the FIMM 720 can be used to help ensure the stringing equipment 200 is operated properly and that the cable is being wound onto the reel properly or paid out from the reel. For example, data received from the FIMM 720 can be used to determine an appropriate speed at which the reel should be rotated and a proper position of the levelwind to ensure the cable is properly wound onto the reel. As will be appreciated by one of skill in the art, the speed at which the reel should be rotated and the speed at which the levelwind should be moved across the reel will vary depending on the size of cable and the particular pulling operation. Accordingly, the FIMM 720 can be used to help ensure the stringing equipment 200 is properly operated to complete the pulling or tensioning operation. Furthermore, as will be appreciated by one of skill in the art, controlling a position of the levelwind 812 based on the actual position of the levelwind 812, as compared to adjusting a flow rate to a hydraulic cylinder to interpolate a position of the levelwind 812 as is currently done in the art, can greatly increase the accuracy of the levelwind 812 and eliminate the need for an operator to calibrate the levelwind 812 positioners. Additionally, controlling the position of the levelwind 812 based on the actual position of the levelwind 812 can prevent drift in position that often occurs over time due to wear or environmental conditions.

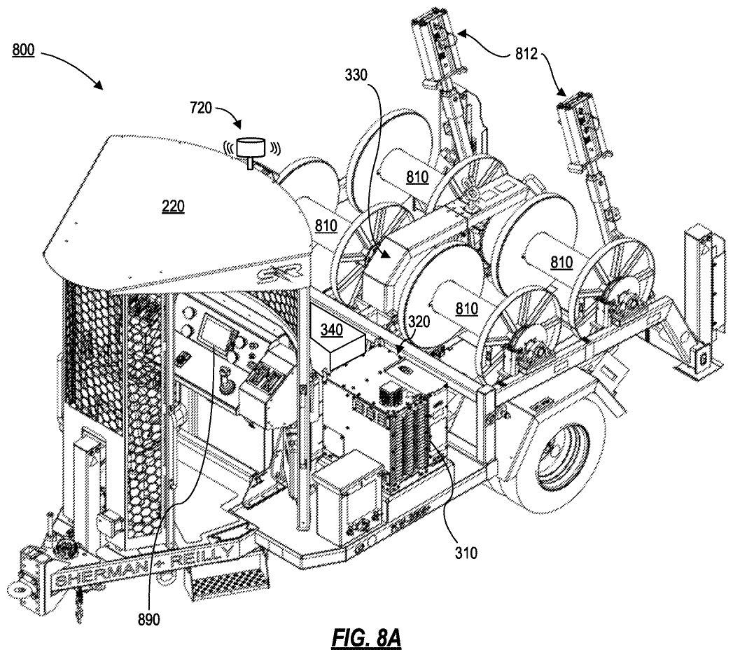

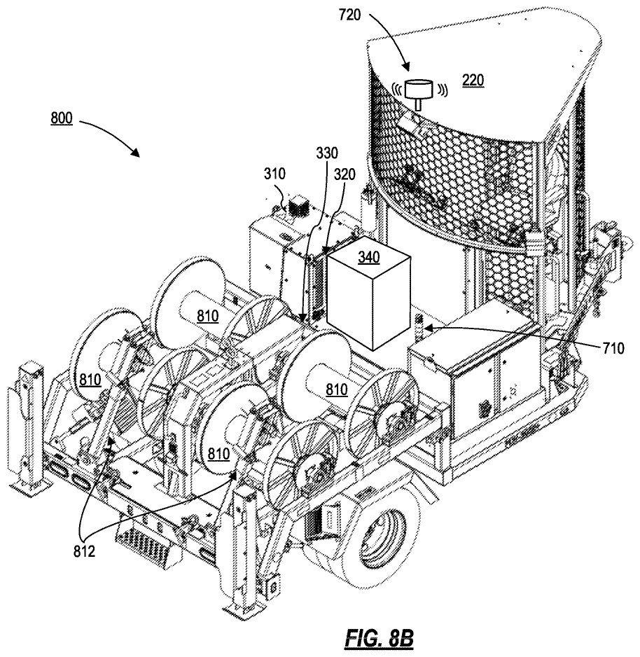

As another example, the FIMM 720 can output data to the control system 380 indicative of the position of more than one levelwind 812 at a time (e.g., two levelwinds 812, three levelwinds 812, four levelwinds, 812, five levelwinds 812, etc.). For instance, on stringing equipment 200 having more than one driveline 210 (such as stringing equipment 800 shown in FIGS. 8A and 8B), existing systems typically operate in a synchronous mode in which both levelwinds 812 (or multiple levelwinds 812) move from side to side at the same time. This is due in large part because it is difficult for an operator to control multiple levelwinds 812 at the same time with accuracy. The FIMM 720, however, can detect the position of each levelwind 812 and output instructions to the control system 380 indicative of the actual position of each level wind, no matter if the levelwinds 812 are in sync together. The control system 380 can then control the position of each levelwind 812 individually even if the drivelines 210 are operating at different speeds, the cables are different sizes, or the levelwinds 812 are just not in sync. In this way, the stringing equipment 200 can operate the levelwinds 812 in ways that have previously been unavailable.

To illustrate further, if the stringing equipment 200 has four levelwinds 812, for example, the FIMM 720 can be configured to detect a position of each levelwind 812 individually. Furthermore, the control system 380 can control each of the levelwinds 812 in an asynchronous mode or a synchronous mode. If operating in a synchronous mode, the control system 380, for example, can control two levelwinds 812 to be in the same relative position while the other two levelwinds 812 are either operating in a synchronous mode with each other or an asynchronous mode. In other words, the control system 380 can be configured to control each levelwind 812, or any combination of levelwinds 812, individually or together with other selected levelwinds 812.

The FIMM 720 can be a lidar-based, radar-based, ultrasonic-based, vision-based, pixel-based, or a photo-electric-based sensor as would be suitable for the particular application. As will be appreciated, the FIMM 720 can be capable of detecting the presence and movement of a person or objects as described herein.

FIGS. 8A and 8B illustrate another example stringing equipment 800 in accordance with the disclosed technology. FIG. 8A is a front perspective view of the stringing equipment 800 while FIG. 8B is a rear perspective view of the stringing equipment 800. The stringing equipment 800 can include an engine 310, a generator 320, an energy bank 340, a motor/generator 330, and multiple drivelines 810 that can each be configured to rotate and receive cable or payout cable depending on the operation.

The stringing equipment 800 can include a console 220 having a user interface 890 configured to display information about the stringing equipment 800 for an operator to view and to receive an input from the operator for operation of the stringing equipment 800. In some examples, the user interface 890 can be configured such that an operator can change a display of the user interface 890. For example, the operator can select between various different views depending on what information the operator would like to view or what task the operator would like to perform. As another example, the user interface 890 can be configured such that an operator can change a brightness level or a viewing mode of the user interface 890. For example, the user interface 890 can be configured to operate in a daytime mode that can include a greater brightness such that the operator is better able to view the screen in bright ambient light. The user interface 890 can further include a nighttime mode in which the brightness can be reduced to make it easier for an operator's eyes to adjust when transitioning between looking at the user interface 890 and other objects. The nighttime mode can further be configured to output a display having the colors inverted (black becomes white and white becomes black) to further reduce the brightness of the display. The user interface 890 can automatically transition between the daytime mode and the nighttime mode depending on the time of day or the detected ambient light. Alternatively, or in addition, an operator can manually select between the daytime or the nighttime modes. Additionally, the user interface 890 can be configured such that an operator can manually increase or decrease the brightness of the user interface 890 while in the daytime mode or the nighttime mode.

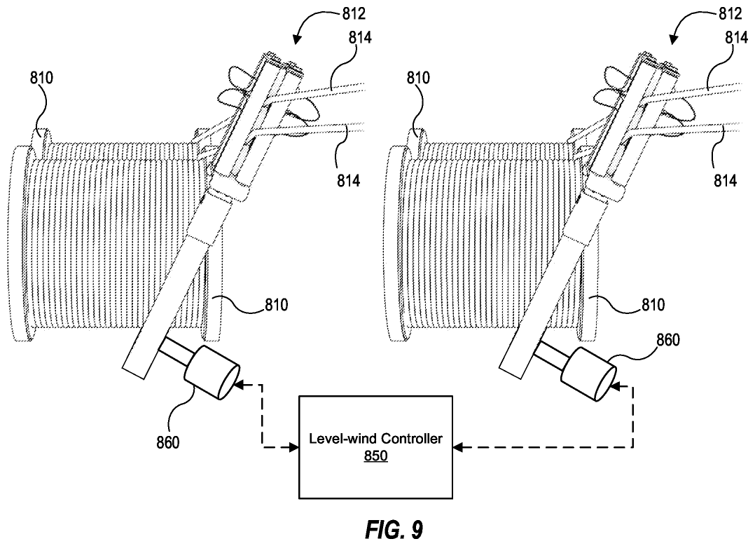

Each driveline 810 can be configured to rotate independent of the other drivelines 810 or to rotate synchronized with the other drivelines 810. The stringing equipment 800 can further include one or more levelwinds 812 that can each be configured to ensure the cable is properly wound onto the respective reel of the driveline 810. The levelwinds 812 can be configured to align with a single driveline 810 or with more than one driveline 810 (as illustrated in FIG. 9).

As illustrated in FIG. 9, the levelwinds 812 can each have an actuator 860 that can be in communication with a levelwind controller 850. The levelwind controller 850 can be the same as, or different from, the controller 380 previously described herein. The actuators 860 can each be configured to change a position of the levelwind 812 by pushing, pulling, and/or rotating the levelwind 812, depending on the configuration, to ensure the cable 814 is moved from one side of the reel to the other side of the reel as necessary. The actuators 860 can each be an electric actuator rather than hydraulic actuators as is commonly used in the art. For example, the actuators 860 can be a smart cylinder, a tailgate cylinder, a linear servo motor, an electric motor on a track or arm, or any other type of electric actuator suitable for the application. The actuators 860 can similarly be a hydraulic cylinder with sensors or a pneumatic cylinder with sensors.

The levelwinds 812 can be configured to automatically change a position of the levelwind 812 as the driveline 810 rotates the reel to ensure the cable is properly wound onto the reel. For example, the actuators 860 can move the levelwind 812 from a first side to the second side of the reel while the driveline 810 rotates such that the cable 814 can be wound around the reel without becoming cross-wound. As described above, the position of the levelwinds 812 can be detected by the FIMM 720 and output to the control system 380 to control the position of the levelwinds 812.

As shown in FIG. 9, the levelwinds 812 can be configured to move in a synchronous mode such that the levelwinds 812 move from one side of the respective driveline 810 to another side of the respective driveline 810 at the same time. The electronic actuators 860 can be programmed to ensure the levelwinds 812 stop when the edge of the reel is reached so that the cable 814 does not fall outside of the reel.

As will be appreciated, the speed at which the levelwind 812 is moved from side to side to distribute the cable 814 onto the reel can vary depending on the size of the cable 814, the load on the cable 814, the wear on the cable 814, reel, or levelwind 812, environmental factors, etc. Accordingly, the levelwind controller 850 can be configured to output instructions to the actuator 860 to ensure the levelwind 812 moves at the proper speed. For example, the levelwind controller 850 can receive data from the FIMM 720 (or other sensors) indicative of the cable 814 size, the cable 814 position, the width of the reel, the diameter of the reel, levelwind 812 position, etc. The levelwind controller 850 can further determine where the levelwind 812 should be positioned and at what speed it should be moving and output instructions to the actuator 860 to ensure levelwind 812 is in the proper position and moving at the proper speed to distribute the cable 814 onto the reel. The levelwind controller 850 or the controller 380 can similarly output instructions to control the speed at which the driveline 810 is rotated to help ensure the cable 814 is properly wound onto the reel.

If the levelwinds 812 are operating in a synchronous mode, more than one levelwind 812 can be moved from one side of the respective reel to another side of the respective reel to properly distribute the cable 814 onto the reel. The levelwind controller 850 can be configured to output instructions to each actuator 860 to ensure each levelwind 812 is properly positioned. If a levelwind 812 is unable to operate in a synchronous mode, the levelwind controller 850 can stop operating the levelwinds 812 in a synchronous mode and can either stop at least one of the levelwinds 812 altogether or can continue operating the levelwinds 812 but in an asynchronous mode.

While several possible examples are disclosed above, examples of the present disclosure are not so limited. For instance, while the system is discussed above with reference to suspending power or communications lines, the system could also be used in many other industries such as transportation (e.g., towing, cables cars, street cars, and trains); rope for climbing, rigging, and boundaries; and virtually any other situation in which lines need to be strung and/or suspended. In addition, while various features are disclosed, other designs could be used.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A stringing apparatus comprising:
a driveline configured to receive a cable;
a levelwind configured to align the cable with a position on the driveline;
a machine monitor configured to detect a position of a plurality of objects on or near the stringing apparatus; and
a control system configured to:
receive data from the machine monitor, the data comprising at least position data indicative of a position of the levelwind; and
output a control signal to adjust a position of the levelwind based at least in part on the position data.

2. The stringing apparatus of claim 1, wherein the machine monitor is further configured to detect a diameter of the cable.

3. The stringing apparatus of claim 2, wherein the control system is further configured to receive diameter data from the machine monitor, and wherein outputting the control signal to adjust the position of the levelwind is based at least in part on the diameter data.

4. The stringing apparatus of claim 1, wherein the driveline is a first driveline, the cable is a first cable, the levelwind is a first levelwind, and the position data is first position data, the stringing apparatus further comprising:
a second driveline configured to receive a second cable; and
a second levelwind configured to align the second cable with a position on the second driveline, and
wherein the control system is further configured to:
receive second position data indicative of a position of the second levelwind, and
output a control signal to adjust the positions of the first levelwind and the second levelwind based at least in part on the first position data and the second position data.

5. The stringing apparatus of claim 4, wherein the control system is configured to adjust a position of the first levelwind and the second levelwind approximately simultaneously.

6. The stringing apparatus of claim 5, wherein the control system adjust the position of the first levelwind and the second levelwind in an asynchronous mode.

7. The stringing apparatus of claim 1, wherein the machine monitor is further configured to detect a presence of a person near the stringing apparatus.

8. The stringing apparatus of claim 7, wherein the machine monitor is further configured to detect a distance between the person and the stringing apparatus.

9. The stringing apparatus of claim 8, wherein, in response to determining that the person is less than or equal to a first distance from the stringing apparatus, the control system is further configured to output an alarm.

10. The stringing apparatus of claim 9, wherein, in response to determining that the person is less than or equal to a second distance from the stringing apparatus, the control system is further configurated to output a control signal to stop the driveline, the second distance being less than the first distance.

11. The stringing apparatus of claim 1, wherein the machine monitor is a photoelectric sensor.

12. The stringing apparatus of claim 1 further comprising:
an energy bank; and
an electric motor configured to receive electric power from the energy bank and to drive the driveline.

13. The stringing apparatus of claim 12 further comprising a temperature sensor configured to detect a temperature of the energy bank and output temperature data indicative of the temperature of the energy bank, and
wherein the control system is further configured to:
receive the temperature data from the temperature sensor; and
in response to determining that the temperature of the energy bank is less than or equal to a minimum threshold temperature, output a control signal to limit an output of the energy bank.

14. The stringing apparatus of claim 12 further comprising a temperature sensor configured to detect a temperature of the energy bank and output temperature data indicative of the temperature of the energy bank, and
wherein the control system is further configured to:
receive the temperature data from the temperature sensor; and
in response to determining that the temperature of the energy bank is greater than or equal to a maximum threshold temperature, output a control signal to limit an output of the energy bank.

15. The stringing apparatus of claim 12, wherein the energy bank is a first energy bank and the stringing apparatus further comprises:
a first port configured to electrically connect the first energy bank to the stringing apparatus;
a second energy bank; and
a second port configured to electrically connect the second energy bank to the stringing apparatus.

16. (canceled)

17. The stringing apparatus of claim 15, wherein the control system is further configured to:
determine an output capacity of the first energy bank and the second energy bank, respectively;
in response to determining that the output capacity of the first energy bank is sufficient to meet an energy demand of the electric motor to drive the driveline, electrically connect only the first energy bank to the electric motor.

18. The stringing apparatus of claim 17, wherein the control system is further configured to, in response to determining that the output capacity of the first energy bank is insufficient to meet the energy demand of the electric motor to drive the driveline, electrically connect both the first energy bank and the second energy bank to the electric motor.

19. (canceled)

20. (canceled)

21. (canceled)

22. A stringing apparatus comprising:
an engine;
a generator to convert power from the engine into electric power;
an electric motor configured to drive a driveline, the driveline being configured to receive a cable; and
a control system configured to:
in response to determining that the engine is operating, output a first control signal to cause the generator to electrically connect to an external load; and
output a second control signal to cause the generator to electrically connect to the electric motor to drive the driveline in a pulling mode.

23. The stringing apparatus of claim 22, wherein the control system if further configured to, in response to determining that the electric motor is driving the driveline, output a third control signal to electrically disconnect the generator from the external load.

24. The stringing apparatus of claim 23, wherein the control system is further configured to:
in response to receiving a stop signal to stop the electric motor from driving the driveline, output a fourth control signal to cause the generator to electrically connect to the external load.

25.-48. (canceled)
